(19) United States
(12) Patent Application Publication
(10) Pub. No.: US 2005/0075938 A1
(43) Pub. Date: Apr. 7, 2005

(54) Technique for simplified user registration of purchased goods using existing communications networks

(75) Inventors: Syunichi Mukai, Fujisawa-shi (JP); Kenji Kawasaki, Yokohama-shi (JP); Kaoru Sudo, Yokohama-shi (JP); Toshiaki Igi, Fujisawa-shi (JP)

Correspondence Address: IBM CORPORATION, IPLAW IQ0A/40-3, 1701 NORTH STREET, ENDICOTT, NY, 13760, US

(73) Assignee: International Business Machines Corporation, Armonk, NY (US)

(21) Appl. No.: 10/403,416

(22) Filed: Mar. 28, 2003

(30) Foreign Application Priority Data
Mar. 28, 2002 (JP) 2002-093208

(51) Int. Cl. G06F 17/60

(52) U.S. Cl. 705/24

(57) ABSTRACT

The present invention provides a technique for simplifying consumer user registration of a product. A removable memory is provided by a manufacturer with a consumer device, such as an electrical appliance, that needs registration for warranty purposes, etc. The memory includes predetermined information, such as consumer information. Later, when a consumer purchases the electric appliance, the removable memory M is mounted in the electric appliance, and the information from the electric appliance is written into the removable memory. The information written into the removable memory is transferred to the manufacturer, employing a portable telephone terminal, a home gateway, or the like, thereby completing the user registration process.

### BACKGROUND OF THE INVENTION

1. Field of the Invention

The present invention relates to a user registration system. More particularly, the present invention relates to a simplified technique for registering consumer products with the manufacturer.

2. Description of the Related Art

Conventionally, if various kinds of electric appliance are purchased, a post card for the user registration is packed.

If the user registration is made, the user can receive by mail the upgrade information of the product, the improvement information for defective portion, and the information on the inspection time if the periodical inspection is required, from the product manufacturer.

On the manufacturer side, the personal information of the user can be acquired to provide the above information, and utilized for the analysis of buyer segments, or a so-called marketing research, based on various information such as age and male/female that are filled in at the time of the user registration.

In recent years, since the Internet has been broadly spread, this user registration operation can be made on the Internet.

However, the percentage at which the user registration is made is as low as about 4% of the total sales of product. In particular, the product manufacturer has a problem that various bits of information may not be provided securely for the user purchasing the product, or there is only limited information when the information collected via user registration is utilized for marketing research.

From old times, electric appliances were sold from a manufacturer's agent to the user, and various sorts of after-sales services were directly provided by the agent. The agent conducts face-to-face selling, and builds a reliable relationship with the user. Traditionally, the expectation is that the user will continually purchase the particular manufacturer's product from that agent. In this manner, a network of agents is deployed by the manufacturer nationwide to sell to and service the users, thereby keeping brand image and loyalty for the manufacturer very high.

However, in recent years, there has been an enormous amount of sales of electronics appliances, and the like by mass market dealers or discount stores. In this case, a user selects such a device from various manufacturers by comparing information such as price and performance. In such environments, consumers tend to stick less to a particular manufacturer than in the past, and it becomes more difficult for a manufacturer to maintain its brand loyalty. As a result, the old-style agents suffer from a decrease in sales and are losing their roles in the market.

The present invention has been created in the light of the above-mentioned technical problems. It is an object of the invention to provide a technique for making consumer registration of purchased devices easy.

### SUMMARY OF THE INVENTION

In this invention, the user has a transportable memory storing the predetermined information such as user ID issued from the manufacturer. When the user purchases an electric appliance since then, the transportable memory is mounted on the electric appliance to write the information on the particular electric appliance into the transportable memory. And the information written into this transportable memory is transferred via a network to the manufacturer side, employing a portable telephone terminal, whereby the user registration is performed on the manufacturer side system.

The present invention concerns an information management apparatus for managing the information on the user for a product, comprising an information storage section for storing the user identification information and the registration information on the user in association, and an information output section for outputting the user identification information stored in the information storage section to be written into the transportable memory. This information management apparatus is applied to a server for accepting the user registration on the manufacturer side, and/or a shop terminal installed at the shop to make the service directly to the user. For example, in a case where the information output section is provided in the server on the manufacturer side, the output user identification information can be written into the transportable memory in the server, or the user identification information output from the information output section is transferred to the shop terminal, and written into the transportable memory at the shop terminal.

Also, this information management apparatus may further comprise a communication section, and an information processing section for appending the product information to the registration information of the specific user matched with the user identification information of the user and storing the appended information in the information storage section, when the communication section receives the user identification information of the user and the product information on the product possessed by the user read from an external transportable memory. Thereby, it is possible to register the information of the product newly purchased by the user associated with the user identification information such as the user ID.

By the way, the privilege information such as a usage point may be generated for the specific user and stored in a privilege information storage section, based on appending the product information to the registration information and storing the appended information in the information processing section. The stored privilege information may be utilized for the discount coupon or cash-back in response to a request of the user.

Further, this information management apparatus may further comprise an information extracting section for extracting the user information of the user that satisfies the predetermined conditions and outputting it. The output of the user information can be utilized for the sales promotion activity of the product of the manufacturer at the shop, for example. Also, the advertisements for the product or service provided by the company can be sent to the user, in response to a request from the company of the third party.

By the way, when this information management apparatus is employed for the shop terminal, it is preferable to further comprise a registration information acquiring section for acquiring the registration information on the user stored in the information storage section. In this way, the user information can be entered at the shop front.

Also, this invention concerns the transportable memory employed in the above way. This transportable memory comprises a device information storage section for storing the device information read from a device on which the memory is mounted, and a user identification information storage section for storing the user identification information as a key in registering the device information for each user in an external database.

A user registration system of the invention comprises an information storage section for storing the personal information of the user acquired from the outside together with the user identification information issued individually to the user, and an information writing section for writing at least the user identification information into the transportable memory mounted in the memory mounting section. This transportable memory is delivered to the user. Also, this user registration system comprises an information processing section for additionally registering the product information in the information storage section with the user identification information as a key, if the product information is transmitted via a network, together with the user identification information written into the transportable memory delivered to the user in purchasing the product.

A device of this invention comprises a memory slot for mounting and dismounting a transportable memory, a device information storage section for storing the device information of its own, and an information writing section for writing the device information stored in the device information storage section into the transportable memory mounted in the memory slot.

Further, the information writing section may write the device information into the transportable memory, upon detecting that the transportable memory is mounted in the memory slot at the first power-on time of the device. Since it is newly installed at the user site. Thereby, the product information is written into the transportable memory without special operation of the user.

In addition, this device may further comprises a firmware update processing section for updating the firmware stored in the firmware storage section with a new version firmware, when the firmware stored in the transportable memory mounted in the memory slot has a newer version than the firmware stored in a firmware storage section.

After the device information acquired from the device in the above way is written into the transportable memory, the user sends out the device information from the communication device such as the portable telephone terminal, PC, PDA or home gateway to the manufacturer side, by mounting the memory in them after dismounting the memory from the newly installed device.

Thus, a communication device of the invention comprises a communication section for making the data communication via a network, a memory slot for mounting a transportable memory, an information reading section for reading the user identification information and the device information on a device possessed by the user from the transportable memory mounted in the memory slot, and an information forwarding section for forwarding the user identification information and the device information read from the information reading section from the communication section.

If the device itself is capable of making the data communication via the network, this device can function as the communication device.

This communication device may further comprise a personal information storage section for storing the personal information on the user, wherein the information forwarding section forwards the personal information appended to the user identification information and the device information.

This invention provides a user registration method for a device, comprising a step of acquiring the personal information of the user and storing it in a database, together with the user identification information issued individually to the user, a step of writing at least the user identification information into a transportable memory, a step of writing the device information on the particular device into the transportable memory, when the transportable memory is mounted in the device possessed by the user, a step of forwarding the device information written in the transportable memory, together with the user identification information, via a network, and a step of additionally registering the device information in the database with the user identification information as a key, when the device information and the user identification information forwarded is received.

Moreover, this invention concerns a program for enabling a computer to perform a predetermined procedure to implement the information management apparatus, the device and the communication device as above described.

That is, the program comprises a process of acquiring the registration information on the user and storing it in a database, associated with the user identification information allocated intrinsically to the user, and a process of appending the particular product information to the user registration information matched with the user identification information of a specific user and storing the appended information in the database, when the user identification information of the specific user and the product information on the product possessed by the user read from an external transportable memory are received.

Also, the invention provides a program for enabling a computer to perform a process of detecting a transportable memory to be mounted, and a process of writing the device information on the computer into the transportable memory.

By the way, in recent years, the apparatus called a home gateway has been noted. One home gateway is installed at each home, and each device capable of using the Internet is connected to the home gateway, which is connectable to the Internet. If the establishment of connection to the Internet is made in this home gateway, each device connected to the home gateway is enabled to use the Internet without individually making the establishment of connection to the Internet. In this way, if the home gateway is installed, the operation for making the establishment of connection to the Internet is dispensed with, and the intensive wiring can be made in the home, whereby the user is given a greater availability. As a result, it is expected to spur the spread of devices capable of using the Internet.

When this home gateway is introduced into the home, communication is made with each device via the cable LAN using the cable, the electric power lines, the radio LAN, or the Bluetooth.

When the device is newly purchased, it is required to make the settings for enabling the transaction via the LAN by associating the newly purchased device with the home gateway.

However, especially in employing the radio LAN, if a plurality of home gateways exist within a reach of electric wave because neighboring dwelling units are closely placed, the device does not distinguish the home gateway of user's home from other home gateways. Therefore, it is foreseen that the ill-willed user makes connection to the home gateway of other home to get rid of the charge, whereby there is a need for building a scheme for making establishment of logical connection between the home gateway and the device safely.

In the light of the above respects, the present invention provides a communication setting method for making the data communication between a gateway connectable to an external network such as the Internet and a device connected via an internal network such as the home LAN to the gateway, comprising a Step of mounting a transportable memory in the device and writing the identification information of the device into the memory, and a Step of mounting the memory in the gateway and registering a device specified based on the identification information read from the memory as the device communicable with the gateway.

Also, this invention concerns a communication device, comprising a device registering section for registering a device communicable in the home network communication section, and a registration processing section for registering a device specified based on the device information read from the transportable memory in the information reading section as the device communicable via a home network (internal network) in the device registering section.

Also, this invention concerns a program for enabling a computer for the communication device to perform a process of reading the user identification information allocated intrinsically to the user and the device information on a device possessed by the user from a transportable memory, a process of registering a device specified based on the read device information as the device communicable via a network, and a process of forwarding the user identification information appended to the device information read from the transportable memory via the network to the outside.

### BRIEF DESCRIPTION OF THE DRAWINGS

FIG. 1 is a block diagram showing the configuration of a user registration system according to a first embodiment of the invention;

FIG. 2 is a flowchart showing a process flow in making the user registration on the management center side;

FIG. 3 is a flowchart showing a process flow for writing the information of a newly purchased electric appliance into memory;

FIG. 4 is a flowchart showing a process flow for registering the product information written in the memory on the management center side;

FIG. 5 is a flowchart showing a process flow for providing the extracted user information from a management center to a shop terminal;

FIG. 6 is a flowchart showing a process flow for distributing an update program; and

FIG. 7 is a block diagram showing the configuration of a user registration system with a home gateway for the user according to a second embodiment of the invention.

### DESCRIPTION OF THE PREFERRED EMBODIMENT

The preferred embodiments of the present invention will be described below in detail with reference to the accompanying drawings.

First Embodiment

In a first embodiment, first of all, a consumer or user registers consumer information with a registrar or manufacturer. While the term manufacturer is employed, it should be noted that any entity which collects consumer information for products is also included. For example, some retailers and manufacturers simply put their name on a product that they do not manufacture themselves such as Sears. Then, a removable memory (transportable memory, portable memory, memory) M having the predetermined information such as the consumer information stored therein is issued from the manufacturer to the user. After that, when the user purchases an electric appliance (device) 100 of that manufacturer, the removable memory M is mounted in a data writer of the purchased electric appliance 100, and information regarding the electric appliance 100 itself is written in the removable memory M. The information written in this removable memory M is transferred to the manufacturer in combination with the consumer information or sufficient consumer information to link the consumer data the manufacturer already has to the consumer and the purchased appliance 100, using a portable telephone terminal (communication device) 40, to complete the user registration of the product. Herein, the removable memory M for use in this embodiment is a transportable memory, such as an SD card, smart media, and flash memory, smart card, data stick or other portable memory device.

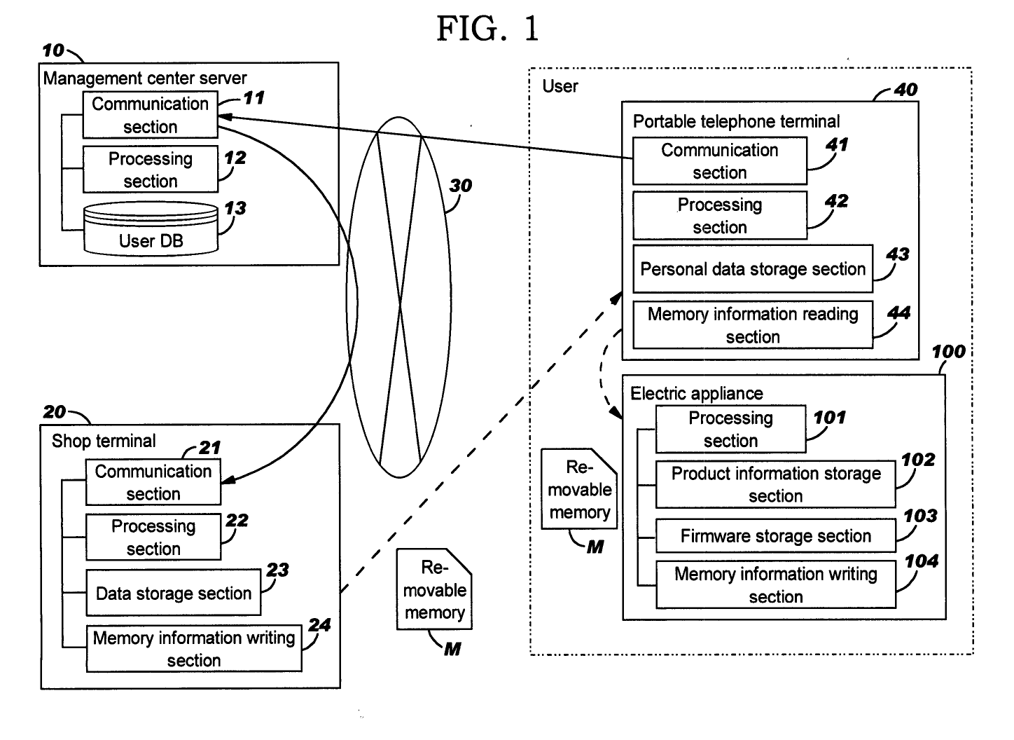

FIG. 1 is a block diagram showing the configuration of a user registration system according to the embodiment.

As shown in FIG. 1, the user registration system comprises a management center server (information management apparatus) 10 that is employed by the registrar or manufacturer, and a shop terminal (information management apparatus) 20 that is employed by each of the manufacturer's agents.

The management center server 10 comprises a communication section 11 for sending and receiving the data via a network 30 such as the Internet or LAN, a processing section (information processing section) 12 for processing the information on the user based on a predetermined program, and a user DB (information storage section, database) 13 for storing the information about the users.

Each of the agents is equipped with the shop terminal 20, which comprises a communication section 21 for sending and receiving data via the network 30 to and from the management center server 10, a processing section 22 for performing processing based on a predetermined program, a data storage section (information storage section) 23 for storing the data transmitted from the management center server 10, and a memory information writing section (information output section) 24 for writing the information into the removable or portable memory M that is delivered to the user.

In this embodiment, the user transmits or receives information to or from the management center server 10, employing the portable telephone terminal 40, such as a cellular telephone. While a portable telephone is described, any device that can read the removable memory media and can communicate with the management center server 10 may be employed. This may include a personal or notebook computer, a non-wireless telephone, etc.

The portable telephone terminal 40 possessed by the user comprises a communication section 41 for sending and receiving data via the network 30 such as the Internet, a processing section 42 for performing a processing based on a predetermined program, a personal data storage section (personal information storage section) 43 for storing the user's name, address and telephone, a memory mounting section, not shown, into which the removable memory M is mounted or inserted for having data written thereto or therefrom, and a memory information reading section (information reading section) 44 for reading the information written in the removable memory M. The memory mounting section may be part of the memory information reading device 44, or attached to a device which may communicate with the data storage section 44.

An electric appliance or device 100 to which the user registration system of this embodiment is applicable may be a consumer electronic device such as a television, a personal or laptop computer, a kitchen appliance, etc. The device 100 must include a component for reading from and writing to a portable memory device M, such as a memory stick or smart card, which includes memory which may be written to. For instance, the device 100 may include a memory mounting section (not shown) for inserting the portable memory device M for reading or writing by a memory information writing section 104. This electric appliance 100 comprises a processing section 101 for performing processing based on a predetermined program, a product information storage section 102 for storing product information (device information, apparatus information) such as the product name, model, configuration and serial number or identification number allocated to each product, a firmware storage section 103 for storing firmware for controlling the operation of the product, a memory mounting section (not shown) for mounting or inserting the removable memory M for reading or writing data therefrom, and a memory information writing section (information writing section) 104 for writing the information into the removable memory M that is mounted in the memory mounting section.

A user registration process in the above user registration system will be described below in succession. Processing is performed by the processing section 12 of the management center server 10, the processing section 22 of the shop terminal 20, the processing section 42 of the portable telephone terminal 40, or the processing section 101 of the electric appliance 100 automatically or upon a predetermined operation or input, based on a predetermined program.

Traditionally, when the user purchases a manufacturer's electric appliance for the first time, the user registers certain user information (personal information) such as the “address”, “name”, “male/female”, “telephone number” and “mail address” with the manufacturer. For example, the user fills in a predetermined form with the user information at the counter of the shop where the user purchases the product, or fills in a post card packed with the product with the user information and sends it to the manufacturer.

The product ID or serial number appended to each electric appliance 100 is preferably entered beforehand in the form or post card. If the “product ID” is not entered, it is necessary to transcribe this product ID into the form or post card by referring to the product itself.

In the case where the user fills in the form at the shop counter, the user information and the “product ID” are input as registered information via a registered information acquiring section, such as a keyboard, into the shop terminal 20, from which the registered information is transmitted via the network 30 to the management center server 10, or the form itself is directly sent to the management center, and the user information filled in the form is input into the server 10 at the management center. In the case of the post card, the destination is the management center, and the “product ID” and registered information filled in the post card are input into the management center server 10 at the management center.

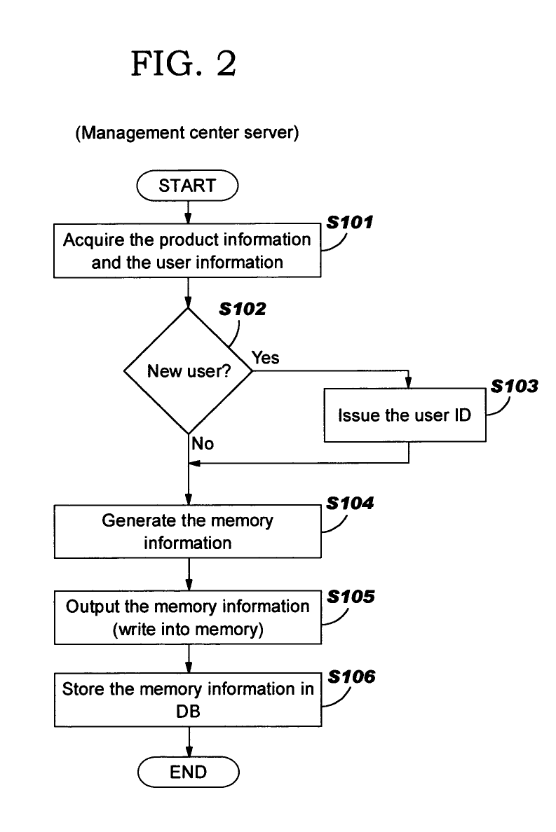

As shown in FIG. 2, the management center server 10 acquires the user information and the product ID in this manner (Step S101).

In addition, in the case where the consumer is affiliated with a membership system of the manufacturer or agent, the consumer information can be acquired from the information of the user as a member that is already held by the manufacturer or special agent. If the consumer uses a credit card to pay for the electric appliance 100, the user information may be provided from the credit card company with the consumer's consent.

If this information is acquired, the processing section 12 performs a following processing, based on a predetermined program, in the management center server 10.

First of all, a determination is made whether or not the user acquiring the user information is already registered in the user DB 13, namely, a new user (Step S102). If so, the “user ID” or consumer ID is issued as the user identification information intrinsic to the user in the processing section 12 (Step S103).

Then, the memory information to be written into the removable memory M is generated for each user ID in the processing section 12 (Step S104). This memory information includes the user information such as “user ID”, “address”, “name”, “male/female”, “telephone number”, and “mail address” and the information such as “product name”, “purchase date”, “purchase shop” and “product ID” for the electric appliance 100 firstly purchased by the user. Furthermore, the “shop ID” for the special agent may be added by designating the special agent having a territory for the “address” of the user.

The generated memory information is output from the management center server 10 (Step S105). If the management center server 10 has the memory mounting section for the removable memory M and the data writing section, the memory information can be written into the removable memory M in the management center server 10. Also, the output memory information may be transferred via the network 30 to the shop terminal 20.

When the memory information is written into the removable memory M in the management center server 10, the removable memory M is directly sent to the user, or the special agent having the territory for the user's address, based on the user's address contained in the user information. In the former case, the sender may be the special agent having the territory for the address of the user.

Also, when the memory information is transferred to the shop terminal 20, the memory information is stored in the data storage section 23 at the shop terminal 20. Furthermore, the received memory information is written into the removable memory M in the memory information writing section 24 to create the removable memory M to be delivered to the user. The removable memory M created at the shop terminal 20 is delivered from the shop to the user by mail or by hand.

Thereafter, the memory information is stored in the user DB 13 for each user ID in the management center server 10 (Step S106).

A process for creating the removable memory M may be made in common between the shop terminal 20 and the management center server 10 while exchanging the data appropriately. For example, the acquisition of the product information or the user information is made at the shop terminal 20, the issuance of the user ID and the generation of the memory information are made mainly on the side of the management center server 10, and the memory information is written into the removable memory M at the shop terminal 20. Thereby, the removable memory M can be delivered to the user when the electric appliance 100 is sold to the user.

In this manner, the user obtains the removable memory M on which the user information containing the “user ID” appended to the user oneself and the product information of the electric appliance 100 purchased ahead are recorded.

Thereafter, when the user newly purchases the electric appliance 100 of the manufacturer providing the user registration system, the user mounts the removable memory M in the memory mounting section of the newly purchased electric appliance 100 and powers on the electric appliance 100.

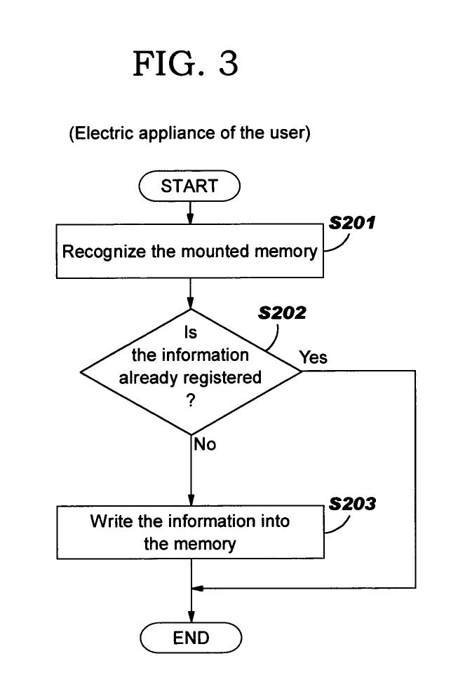

Then, it is detected (recognized) in the electric appliance 100 that the removable memory M is mounted in the memory mounting section (not shown), as shown in FIG. 3 (Step S201).

First of all, the processing section 101 confirms whether or not the data of the electric appliance 100 itself is registered in the mounted removable memory M (Step S202). If it is registered, the processing is ended.

If it is not registered, the processing section 101 reads the “product name” and product ID or serial number of the electric appliance from the product information storage section 102, and writes them in the removable memory M in the memory information writing section 104. Furthermore, if the electric appliance 100 has a calendar function or a clock function, the current date as the “registration date” is written into the removable memory M.

In this manner, the process of writing the product information into the removable memory M is completed (Step S203).

Thereafter, the user removes the removable memory M from the electric appliance 100, and then mounts it in the memory mounting section for the portable telephone terminal 40 of the user (or other person).

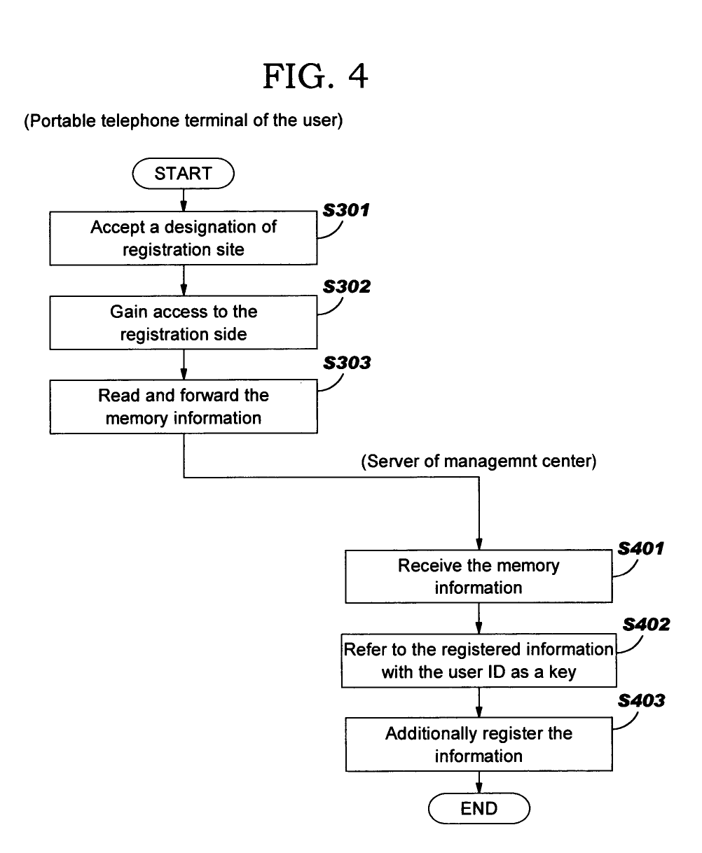

The user then designates a registration site for making the user registration provided by the manufacturer from a menu screen of the portable telephone terminal 40. Then, the processing section 42 of the portable telephone terminal 40 accepts a designation of the registration site and gains access to the registration site from the communication section 41 via the network 30, as shown in FIG. 4 (Steps S301 and S302).

Further, if the user selects a menu of product registration on the menu screen of the portable telephone terminal 40, the memory reading section 44 reads the memory information written in the removable memory M mounted in the memory mounting section, and forwards it from the communication section 41 via the network 30 to the management center server 10 (Step S303).

The forwarded memory information contains at least the user ID and the product information such as product name and product ID of the electric appliance 100 newly purchased.

By the way, the portable telephone terminal 40 has stored the personal information such as the name of its bearer. Accordingly, when the portable telephone terminal 40 of its own is used, the personal information such as the name may be acquired from the portable telephone terminal 40 and added to the memory information in forwarding the memory information.

In the management center server 10, the communication section 11 receives the memory information transferred via the network 30 (Step S401).

Then, the information stored in the user DB 13 is retrieved with the user ID contained in the received memory information as a key to refer to the registered information associated with the user ID (Step S402).

The product information such as the product name and product ID of the newly purchased electric appliance 100, associated with the user ID, is additionally registered by adding to the registered information (Step S403). In this manner, the user ID is employed as the key associating the newly purchased product information with the registered information.

Thereby, the information on the electric appliance 100 that the user newly purchased is registered on the side of the management center.

The above processing may be performed exactly in the same manner every time of newly purchasing the electric appliance 100 of that manufacturer. In this manner, the product information is added successively to the removable memory M possessed by the user, and accumulated in the management center server 10.

The management center server 10 transfers the additional information via the network 30 to the shop terminal 20 of the special agent in charge of the user, when the user additionally registers the information on the newly purchased electric appliance 100, as above described.

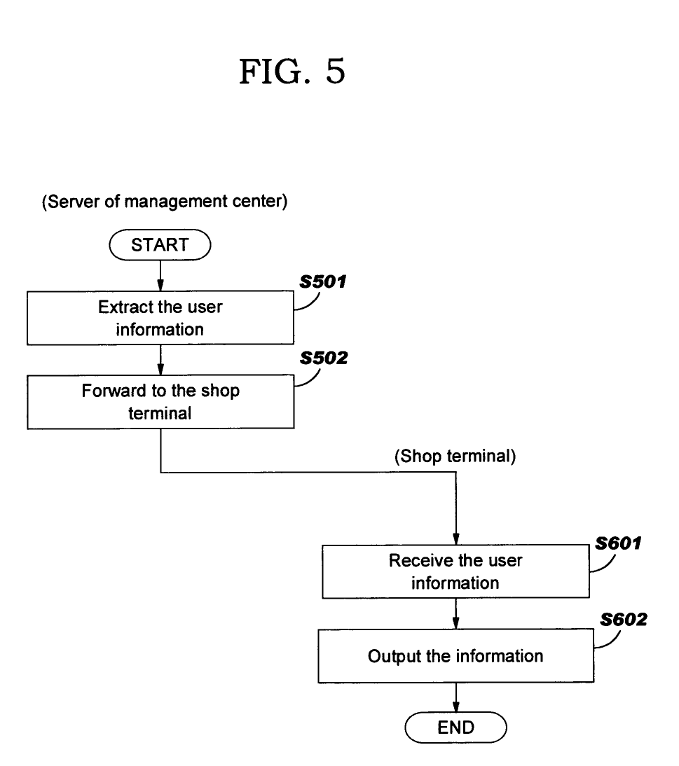

Apart from this, in the management center server 10 as shown in FIG. 5, the processing section 12 functions as an information extracting portion to periodically extract the user information from the user DB 13, for each special agent and transfer it via the network 30 to the shop terminal 20, (Steps S501 and S502).

At the shop terminal 20 of each special agent, the user information for that special agent is received via the network 30 by the communication section 21, and stored in the data storage section 23 (Step S601).

On the side of the special agent, the user information stored in the data storage section 23 is output at an appropriate timing (Step S602).

Thereby, in this special agent, the user information within the territory can be acquired in a comprehensive way, and the introduction of new product to the user, the visiting sales, and the sales of the articles of consumption for the electric appliance 100 possessed by the user can be approached, based on the acquired user information. Since the purchasing history of the electric appliance 100 can be grasped for each user, the positive sales activity for the demands of selling and buying the product again can be made by referring to the previous purchase time.

In the management center server 10, for example, when a bug is found in the firmware of a certain electric appliance 100 and a correction program for correcting the bug is created, or an update program for updating the program with a new function is created, this program (hereinafter referred to as an updating program) can be distributed to the user possessing that electric appliance 100, based on the information stored in the user DB 13.

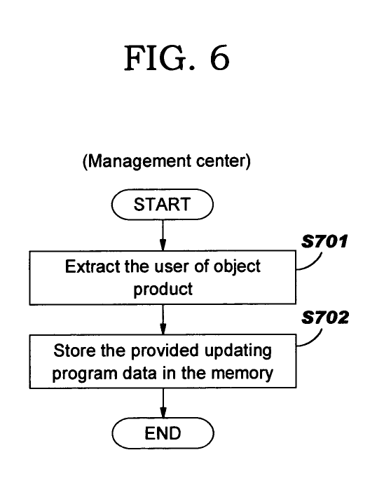

That is, the processing section 12 of the management center server 10 as an information extracting section retrieves the information stored in the user DB 13, with the product name or product ID of the electric appliance 100 to be an objective of the updating program as a key, as shown in FIG. 6. Then, the user possessing the electric appliance 100 to which this updating program is to be distributed can be extracted (Step S701).

The processing section 12 stores the data of the updating program to be provided in the new removable memory M (Step S702), which is then delivered by mail or by hand via the special agent to the extracted user. If the mail address of the user has been acquired in the user DB, the updating program can be forward to the mail address with an electronic mail. Or the URL uploading the updating program may be notified by the electronic mail to the user, who is prompted to gain access to this URL.

In the case where the updating program is stored in the removable memory M and delivered to the user, the user receiving the removable memory M mounts the removable memory M in the memory mounting section of the electric appliance 100 of object.

On the side of the electric appliance 100, the processing section 101 functions as a firmware updating section to detect the mounted removable memory M and determine whether or not the firmware stored in the removable memory M is a newer version than the firmware stored in the firmware storage section 103 at present. In the case of the newer version, the firmware is read from the removable memory M, and the firmware stored in the firmware storage section 103 is updated. For the firmware of new version, the user may be prompted to answer a confirmation of “Update or not?”, as needed, to execute the update of the firmware when an input of “Update” is made.

The management center can comprehensively grasp which electric appliances 100 each user possesses, thereby marketing the contents distribution or the data backup service according to the electric appliance 100 possessed, for example.

In addition, the management center can provide the information to the contents service company on the basis of the data stored in the user DB 13. For example, when there is a company for distributing the music contents to the home, the processing section 12 of the management center functions as an information extracting section to extract the user for the predetermined electric appliance 100, for example, an audio apparatus for reproducing the music contents, stored in the user DB 13, on the basis of the approach from this company to the management center or approach to this management center. The management center may deliver the advertisement of the contents based on a request from the company to the extracted user, employing means of the direct mail or electronic mail, or calling on the shop. Thereby, the management center can get a compensation for the target marketing from the company.

By the way, the manufacturer operating the management center can get various merits by accepting the information registration from the user, as described above. Accordingly, it is contemplated that the user is given a privilege (privilege information) such as cash back or membership points. This privilege serves to raise an information registration ratio from the user.

One of the privileges is a point in consideration of the registration number or price of the electric appliance 100 for each user ID, and kept in the user DB (privilege information storage section) 13 on the side of the management center server 10, thereby making a discount corresponding to the point, or issuing a coupon, when the user buys the electric appliance 100 at the next time.

If the information registration is made via the portable telephone terminal 40, it is possible to make a cash back (discount) for the portable telephone terminal fee in cooperation with a carrier of this portable telephone terminal 40.

With the above configuration, once the user registers the user information to the manufacturer, the product information on the electric appliance 100 is automatically written from the newly purchased electric appliance 100 into the removable memory M if the user mounts the removable memory M storing the user information in the electric appliance 100. The user mounts the removable memory M in the portable telephone terminal 40, and gains access to the management center server 10, the newly purchased electric appliance 100 can be easily subjected to the user registration. That is, when the electric appliance 100 is newly purchased, the user registration can be easily made without filling in the post card for the user's address and name at every time.

By the way, in the electric appliance 100, the product information is written automatically into the removable memory M, only if the removable memory M is mounted in the memory mounting section. Thereby, there is no need of performing the input operation on the user side, whereby this invention is also applicable to the electric appliance 100 having no specific operation means, for example, a refrigerator.

On the other hand, on the manufacturer side, it is expected to increase a withdrawal ratio of the user registration, because the user can make the user registration very easily as described above. Since the management center server 10 can make the information management with the user ID as a key, if there are plural users with the same name, it was conventionally necessary to make a complicate confirmation operation, but this operation can be dispensed with, thereby making the management affairs more efficient.

Moreover, on the manufacturer side, the user registration is made more securely to distribute the updating program for correcting the bug or enhancing the function to the user, whereby the after-sales service as the manufacturer can be more suitably arranged.

Moreover, the management center server 10 can provide the user information to the special agent taking charge of the user, and the special agent can make a sale or approach for the user. When the user purchases the product for the first time, the removable memory M is sent to the user in the name of the special agent, or directly delivered to the user, thereby building a reliable face-to-face relationship with the user. Thereby, it is expected that the user purchases the product continually to give rise to a so-called enclosing effect of the user. Accordingly, the special agent can be provided with an organic role.

Additionally, the information acquired from the user can be utilized not only for the marketing or target sales of its own company, but also the marketing or target sales upon a request from the contents distributing company of the third party, whereby the manufacturer can get a compensation from the company to provide the economical effect for the manufacturer and the outside company.

In this manner, the manufacturer can attain an enhanced brand image totally.

Second Embodiment

In a second embodiment, the information on an electric appliance (device) 200 newly purchased (product information, device information) is written into the removable memory M, and transferred to the management center server 10 to make the user registration to the manufacturer in the same manner as in the first embodiment. In the second embodiment, a home gateway (communication device, gateway) 60 is employed, instead of the portable telephone terminal 40 employed in the first embodiment, whereby the information written in the removable memory M is transferred to the management center server 10. In the following description, the common parts are designated by the same numerals through the first and second embodiments, and description of those parts is omitted.

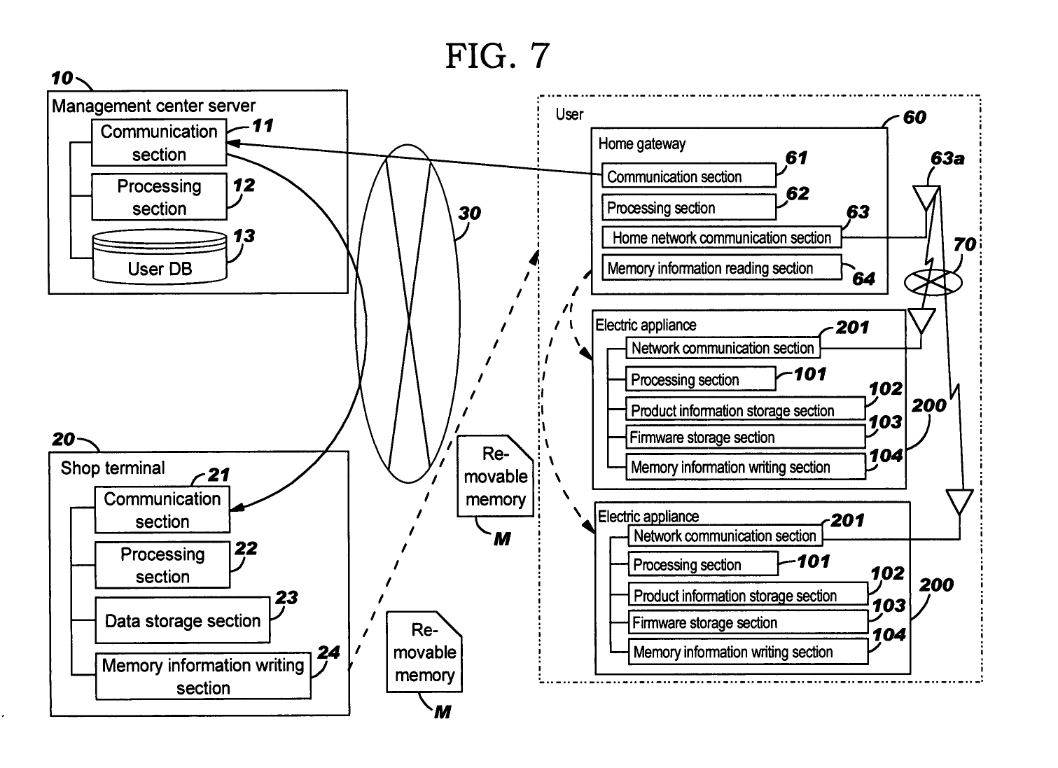

A user registration system composed of the management center server 10 and the shop terminal 20 and provided by the manufacturer as shown in FIG. 7 has the same configuration as in the first embodiment.

On the contrary, the user has a home gateway 60 to construct a home network in the home in this embodiment.

The home gateway 60 comprises a communication section 61 for making the data communication via the network (external network) 30 such as the Internet, a processing section 62 for performing a processing based on a predetermined program, a home network communication section 63 for making the data communication with each device (electric appliance 200) making up the home network, a memory mounting section (not shown) for mounting the removable memory M, and a memory information reading section (information reading section) 64 for reading the information written in the removable memory M that is mounted in the memory mounting section.

In this embodiment, the home network communication section 63 makes the communication via an internal network 70 made up of a cable network using the LAN cable or lighting wire, or a radio network such as Bluetooth. Therefore, the home network communication section 63 is equipped with an antenna 63a for short distance communication.

The electric appliance 200 to which the user registration system of this embodiment is applicable is limited to those having the memory mounting section (not shown) for mounting the removable memory M, and capable of making the data communicate with the home gateway 60 via the internal network 70.

This electric appliance 200 comprises a processing section 101 for performing a processing based on a predetermined program, a product information storage section 102 for storing beforehand the product information such as the product name and product ID allocated to each product, a firmware storage section 103 for storing a firmware controlling the operation of the product, a memory mounting section (not shown) for mounting the removable memory M, a memory information writing section 104 for writing the information into the removable memory M that is mounted in the memory mounting section, and a network communication section 201 for making the data communication via the internal network 70.

The user registration system as above performs the process for firstly making the user registration and accepting the removable memory M storing the user information in the same manner as in the first embodiment of FIG. 2.

When the user newly purchases the electric appliance 200 of the manufacturer providing the user registration system since obtaining the removable memory M, the user mounts the removable memory M in the memory mounting section of the newly purchased electric appliance 200 and powers on the electric appliance 200.

Then, the electric appliance 200 performs the process as shown in FIG. 3 to write the product information into the removable memory M.

Thereafter, the user removes the removable memory M from the electric appliance 200, and subsequently mounts it in the memory mounting section of the home gateway 60.

The user makes a request for gaining access to the registration site for the user registration provided by the manufacturer via the home gateway 60. Then, the processing section 62 of the home gateway 60 accepts a designation of the registration site, and enables the communication section 61 to gain access to the registration site via the network 30, as shown in FIG. 4 (Steps S301 to S302).

Upon mounting the removable memory M in the memory mounting section of the home gateway 60, the communication section may automatically gain access to the user registration site to start the user registration process.

Further, if the home gateway 60 makes access to the management center server 10, the memory information reading section 64 reads the memory information written in the removable memory M mounted in the memory mounting section, and the communication section 61 forwards this memory information via the network 30 to the management center server 10 (Step S303). The forwarded memory information at least contains the user ID, and the product information such as the product name and product ID of the newly purchased electric appliance 200.

Then, in the management center server 10, the memory information transferred via the network 30 is received by the communication section 11 (Step S401), the information stored in the user DB 13 is retrieved to refer to the registered information associated with the user ID (Step S402), and the product information such as product name and product ID of the newly purchased electric appliance 200 is additionally registered associated with the user ID (Step S403).

Thereby, the information on the electric appliance 200 newly purchased by the user is registered on the side of the management center.

The home gateway 60 performs the same process for the user registration as in the first embodiment. Furthermore, in constructing the home network using the home gateway 60, it is required to make establishment of connecting the newly purchased electric appliance 200 to the home gateway 60, whether the internal network 70 is the cable network or the radio network such as the Bluetooth. In particular, when the internal network 70 is the radio network, a plurality of home gateways 60 are seen from the electric appliance 200 depending on the environment. Namely, the home gateway 60 for other adjacent homes is in the environment where the radio communication is enabled.

Therefore, in making the establishment of connection to the correct home gateway 60, first of all, the removable memory M is mounted in the memory mounting section of the electric appliance 200. Then, in the electric appliance 200, the product information such as “product ID” of the electric appliance 200 is written in the removable memory M.

If the user mounts the removable memory M in the memory mounting section of the home gateway 60 this time, the memory information reading section 64 in the home gateway 60 reads the memory information written in the removable memory M and acquires the “product ID” contained therein.

In the home gateway 60, the product ID of the newly purchased electric appliance 200 is acquired. The processing section 62 functions as a registration processing section to register the product in a non-volatile memory (device registering section), not shown, as a device having the legal access right and make a negotiation based on the product ID, when communication is established with the electric appliance 200.

Thereby, even when the radio network is employed for the internal network 70, an illegal access to the home gateway 60 can be prevented.

By the way, the establishment of connecting the electric appliance 200 to the home gateway 60 in a series is nothing but the process for making the user registration for the electric appliance 200. Namely, if the user only performs an operation of mounting the removable memory M in the memory mounting section of the electric appliance 200 to make the user registration to write the product information in the removable memory M, and then mounting the removable memory M in the memory mounting section of the home gateway 60, the establishment of connection to the home gateway 60 can be completed at the same time.

In the first and second embodiments, the user makes the user registration via the portable telephone terminal 40 or the home gateway 60 to the management center server 10, but other configurations may be taken. For example, the removable memory M may be mounted in the memory mounting section of the shop terminal 20 to read the information from the removable memory M, and transfer it to the management center server 10. In this case, when the user purchases the product, the removable memory M of the user is mounted in the memory mounting section of the product at the shop and the apparatus is started up to write the product information in the removable memory M. Thereafter, the removable memory M is removed from the product, and mounted at the shop terminal 20 to make the registration process. In this case, the removable memory M issued to the user may be stored at the shop side.

In updating the firmware, the removable memory M is kept from the user, and the firmware is downloaded into the removable memory M at the shop terminal 20. Then, the removable memory M is delivered to the user, and the user mounts this removable memory M in the memory mounting section of the electric appliance 100 or 200 to update the firmware.

Adopting the above configuration, the user, who may be unfamiliar with the handling of the electric appliance, can enjoy the same services, and related more securely with the shop, whereby the shop can have a more important role.

As above described, with this invention, the user registration of the product can be easily made, whereby it is expected that the user has a greater availability and the manufacturer can enhance the service and the brand image.

1. An information management apparatus for managing consumer registration information for a product, said apparatus comprising:
information storage means for storing consumer identification information for a consumer and product registration information for a product purchased by the consumer in association; and
information output means for writing consumer identification information stored in said information storage means to a portable memory device.

2. The information management apparatus according to claim 1, further comprising:
communication means for communicating the consumer identification information via a network to the consumer; and
information processing means for appending the product registration information to the registration information of a specific consumer matched with the consumer identification information and storing the appended information in said information storage means, when said communication means receives the consumer identification information of the consumer and the product information on the product possessed by the consumer read from the portable memory device.

3. The information management apparatus according to claim 2, further comprising:
privilege information storage means for generating privilege information for the specific consumer and storing the privilege information, based on appending the product information to the registration information and storing the appended information in said information processing means.

4. The information management apparatus according to claim 1, further comprising:
information extracting means for extracting stored information about consumers of consumers which satisfy predetermined conditions and outputting the stored information.

5. The information management apparatus according to claim 1, further comprising:
registration information acquiring means for acquiring the registration information for a consumer stored in said information storage means.

6. A consumer product registration system comprising:
information storage means for storing personal information of a consumer together with individualized consumer identification information;
information writing means for writing at least the individualized consumer identification information into a portable memory; and
information processing means for registering product information tied to the personal information of the consumer in said information storage means, if the product information is transmitted via a network, together with the consumer identification information written into the transportable memory.

7. In an electronic device, a system for permitting simplified product registration of the electronic device, said system comprising:
means for storing electronic device information required for registering the electronic device with a registarar; and
means for writing the electronic device information; to a portable memory device.

8. The system according to claim 7, wherein said system further comprises means for determining whether the portable memory device is accessible when the device is initiated, wherein said writing means writes the electronic device information into the portable memory device if said determining means detects that the portable memory device is accessible upon initiation.

9. The system according to claim 7, wherein said writing means further comprises means for reading information from the portable memory device, said system further comprising:
firmware storage means for storing firmware controlling operation of said electronic device; and
firmware update processing means for updating firmware stored in said firmware storage means with updated firmware if firmware stored in the portable memory device has a newer firmware version than the firmware stored in said firmware storage means.

10. A communication device comprising:
communication means for enabling data communication via a network;
a memory mounting section for mounting and dismounting portable memory;
information reading means for reading consumer identification information and device information for a device possessed by a consumer from the portable memory mounted in said memory memory mounting section; and
information forwarding means for forwarding the consumer identification information and the device information read by said information reading means via said communication means.

11. The communication device according to claim 10, further comprising:
personal information storage means for storing the personal information for the consumer, wherein said information forwarding means forwards the personal information with the consumer identification information and the device information.

12. The communication device according to claim 10, further comprising:
home network communication means enabling the data communication via a home network;
device registering means, connected to said home network communication means, for registering a device connected to said home network communication means; and
registration processing means for registering, based on the device information read from the portable memory by said information reading means, the device communicated to by said device registering means.

13. A consumer registration method for registering a consumer electronic device, said method comprising the steps of:
acquiring personal information of a consumer and storing it in a database together with the consumer identification information issued individually to the consumer;
writing at least the consumer identification information into a portable memory;
writing device information for a consumer electronic device into the portable memory when the portable memory is in communication with the consumer electronic device possessed by the consumer;
forwarding the device information written in the portable memory together with the consumer identification information via a network; and
registering the device information in the database using the consumer identification information as a key when the device information and the consumer identification information forwarded is received via the network.

14. The consumer registration method for the device according to claim 13, further comprising the steps of:
determining which consumers meet specified conditions based on the consumer identification information, the personal information and the device information stored in the database; and
outputting a list of the consumers that meet the specified conditions.
